(19) United States
(12) Patent Application Publication
(10) Pub. No.: US 2006/0143232 A1
(43) Pub. Date: Jun. 29, 2006

(54) Computer-implemented method for data management

(76) Inventors: Stephan Ernst, Wurenlos (CH); Markus Schumann, Wallisellen (CH)

Correspondence Address: PILLSBURY WINTHROP SHAW PITTMAN LLP, 1650 TYSONS BOULEVARD, MCLEAN, VA, 22102, US

(21) Appl. No.: 11/263,841

(22) Filed: Nov. 2, 2005

(30) Foreign Application Priority Data
Dec. 13, 2004 (EP) 04 029 463.9

(51) Int. Cl. G06F 17/00

(52) U.S. Cl. 707/104.1

(57) ABSTRACT

Suggested is a computer-implemented method for data management, in which method a service provided or to be provided by a service provider, such as the implementation of a customer order, is represented by electronic data on the basis of an information model, which defines a large number of different but related information objects (10, 12, 14, 16), by which the service can be represented. The method includes the generating of a large number of data records, which each represent one of the information objects. For at least some of the information objects, the data records each contain a time stamp, which represents the time of generation of the data record concerned. The method also includes the generating of several data records each representing a different version of the same information object, these data records differing from each other at least in their time stamp.

In many organizations, and also in public bodies, massive volumes of data accumulate nowadays in connection with the provision of services. It is necessary to represent these services in a structured and systematic data system, in order that the background and details of the processes involved in the data flow can be traced at any time. Suitable modelling of the services at data level should also enable the stored data to be used later for evaluations without problems.

Banks are one example of a service provider. In banking, an increasing differentiation in the offered services and prices has emerged in recent years and even decades. Earlier standard services (current account, securities account) with few variants are being replaced by an ever greater number of different services and price alternatives. The range of financial instruments on offer becomes continually wider, and the individual financial instruments more creative and sophisticated.

At the same time, customers' demands on banks are also growing, in terms of transparency, consistency and completeness of the information supplied to the customer by the bank. Many customers are no longer satisfied with simple statements on the current balance of their account. Demanding and wealthy customers especially, who make use of a number of different services of a bank, for example because they carry out transactions in securities, property and other investments through the bank, demand complete and detailed information about any business case, and quickly. For automated preparation of a financial statement for a customer, detailed information is then necessary about all transactions relating to the customer's assets, whether cash transactions, securities business or similar.

Considering that banks handle many thousands of transactions daily, even hundreds of thousands, it is easy to see how large are the volumes of data to be coped with and saved in modern banking systems. Naturally, this is true not only for banks but also for numerous other organizations of an entrepreneurial or administrative nature.

It is the object of the invention to set forth a way of enabling a large number of different kinds of services of a bank or other organization to be represented in a structured and systematic way at the level of electronic data.

To achieve this object according to the invention, a computer-implemented method for data management is provided, within which method a service provided or to be provided by a service provider is represented by electronic data on the basis of an information model, which defines a large number of different but related information objects, by which the service can be represented, the method including the generating of a large number of data records which each represent one of the information objects, the data records for at least some of the information objects each containing a time stamp, which represents the time of generation of the data record concerned, and the method further including the generating of several data records each representing a different version of the same information object, these data records differing from each other at least in their time stamp.

In the method according to the invention, services provided or to be provided are mapped on several data records according to a preferably at least partially hierarchically organized model, each data record defining an information object. By using a model that defines several different information objects (entities) with which a service can be represented as a whole, high flexibility is achieved, which enables the model to be applied on numerous different types of services. For example, one information object can define the service in its wider scope, while other information objects can represent individual partial aspects of the service.

In the solution according to the invention, at least some of the data records generated to represent a service contain a time stamp. The provision of such a time stamp is advantageous, because it enables versions to be generated for an information object. If the execution or conclusion of a service results in a change of status, for example, of one or more of the information objects representing this service, then the data records associated with the changed information objects need not be modified. Instead, “copies” of these data records can be generated, containing a correspondingly later time stamp. Several data records can thus be assigned to one information object at data level, each of these data records describing one version of the information object at a respectively different point in time.

As a result of the version creation enabled by the time stamps for information objects, the various life cycles or development statuses of the information objects can be retrospectively traced, but there is also the advantage that complex modifications to existing data records are avoided. Especially in large databases with many millions of entries, it can save time simply to write a new, slightly modified data record rather than making a modifying access to an existing data record.

For at least some of the information objects, the data records can contain a status field with a status entry, which represents a status of the relevant information object. In other words, this status relates not to the data record itself, but to the aspect, represented by the data record, of the service provided or to be provided. For example, the status can relate to the current state of a single transaction or an entire business case, which possibly includes several such individual transactions.

It was already mentioned that the information model used is preferably at least partially hierarchically organized. The information model can then define information objects at least on an upper, middle and lower hierarchy level, with information objects of a lower level each being assigned uniquely to one information object of a next higher level. With such a hierarchy, a tree structure of logically interconnected data records can be developed, in which several data records can be present on at least some of the tree nodes, these data records then representing different versions of the same information object.

A unique logical linking of several data records belonging to the same service can be achieved, for example, if each of these data records contains a service identification assigned uniquely to the service.

In a preferred embodiment, the time stamp contains a date and a time, although other forms of time representation are equally possible, in particular a representation according to the UTC time standard (UTC=Universal Time Coordinated).

The invention further relates to a computer program product, which causes the execution of the method of the kind described above, when it is processed by a computer. The computer program product can be stored, for example, on a computer-readable magnetic or optical information carrier (such as a CD-ROM or a minidisk).

The invention will be further described on the basis of the included drawings. Shown are:

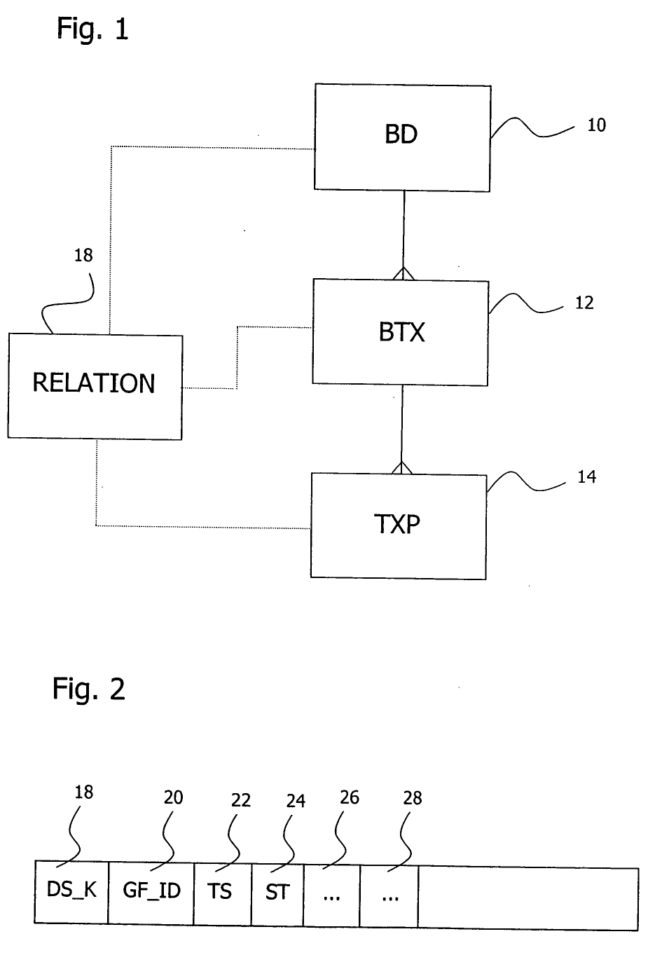

FIG. 1 a model shown as an example of the representation of business cases in a data system,

FIG. 2 an example of a data record format,

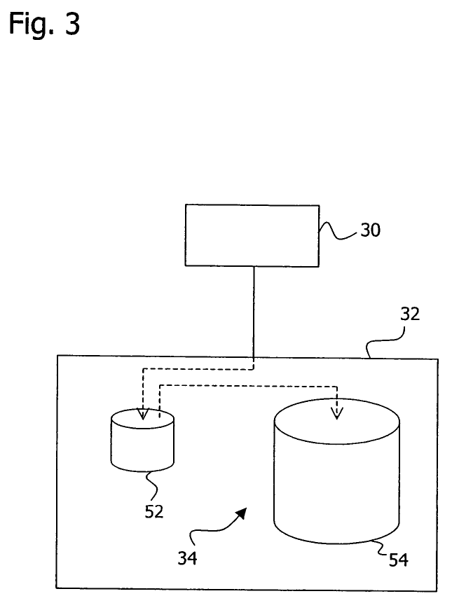

FIG. 3 a schematic example of architecture for performing the method according to the invention and

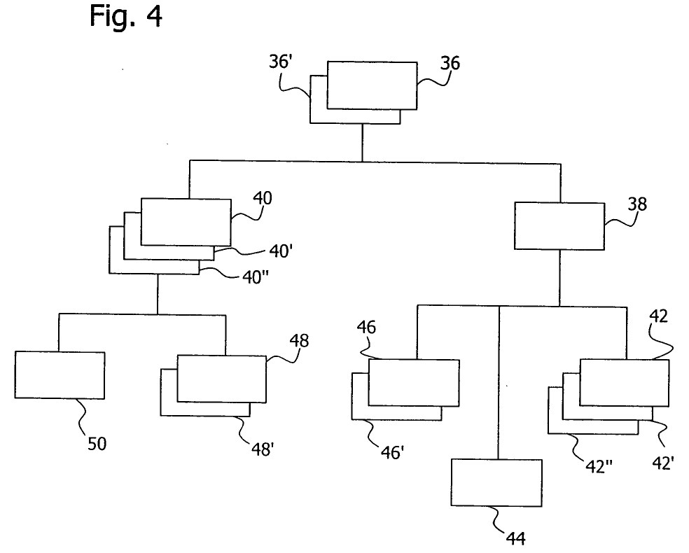

FIG. 4 an example of a data tree for a business case.

FIG. 1 shows various information objects 10, 12, 14, 16 of an information model, according to which, in an embodiment of the invention, banking subjects in particular are represented in a data system. To represent a subject, the information objects are effectively put together like Lego bricks to form a complete picture. According to the information model, one or more information objects 12 (“BTX”) can be assigned to an information object 10 (“BD”), and one or more information objects 14 (“TXP”) can be assigned in turn to each information object 12. The information objects 10, 12, 14 are linked into a hierarchical structure, where the information object 10 is the highest in the hierarchy, while the information objects 12 are in the middle of the hierarchy and the information objects 14 are at the bottom of the hierarchy.

Further information objects can be defined additionally in the information model, in particular an information object 16 (“RELATION”). These further information objects need not be linked into the hierarchy of information objects 10, 12 and 14: they can be outside the hierarchy.

It has emerged that such an information model is especially well suited to modelling services of a bank in a data system. The information object 10 can be used to describe the overall service agreed with a customer (business case), the information object 12 to describe a single service (transaction) provided by the bank within the overall service, and the information object 14 to represent a transaction object processed (e.g. moved, created, sent) by the bank within the provision of the relevant single service. Typical single services are for example a single payment transfer, a share purchase on the stock exchange, an interest statement, an address change or the preparation (printing and dispatching) of a settlement for a share purchase. A transaction object can be e.g. a value lot, which defines a set of a financial instrument (share, money, debt security) moved within a transaction. Another transaction object can be the price or transaction value of a value lot. Transaction objects can also represent tax valuations, stock exchange settlements, contract or customer data and other structured information, which are related to a service provided in the bank's customer business. These are naturally only examples of possible transaction objects, and by no means exhaustive.

Since an overall service can be made up of several single services and each single service can contain several processed objects, it must be clear that several information objects 12 can be assigned to each information object 10, and several information objects 14 to each information object 12; however, each information object 14 is always assigned to one single information object 12 only, and each information object 12 is always assigned to one single information object 10 only.

Information objects 16 can further be used to describe connections (relations, dependences) between different business cases (such as a cancellation order to an original order) and within a business case (e.g. assignment of charges for a remuneration within a collective payment order). The information objects 16 are always directed, i.e. they always connect an initial entity with a target entity. The entities connected by an information object 16 can in principle be any entities. For example, an information object 16 can represent a relationship between two information objects 10 or between two information objects 12 or between two information objects 14 or between an information object 10 and an information object 12 or between an information object 12 and an information object 14, and so on. The connected entities can be identified in an information object 16 by unique identification codes. As it can be imagined that various relationships with differing semantic significance can exist between two information objects, it can happen that multiple information objects 16 are needed to describe the relationships between two information objects.

In the embodiment described here, each information object is described by a data record, and at least for the information objects 10, 12, 14 each data record represents one version of the information object in question. To achieve reciprocal assignment of information objects at data level too, an identification number can be assigned for each customer order that results in a business case, and this identification number can be inserted in each data record that represents an information object of the relevant business case.

FIG. 2 shows an example of a data record format, which can be used for the data records representing the information objects 10, 12, 14, and if applicable also for data records of other information objects. All data records have a number of data elements, of which only part is shown in FIG. 2. In particular, each data record has as a data element held in a data field 18 a data record identifier DS_K, which can contain an indication of the type of information object involved which is represented by the relevant data record, in other words an information object 10 or an information object 12 or an information object 14. Furthermore, according to the data format of FIG. 2, an identification number GF_ID entered in a data field 20 is provided as a further data element, uniquely identifying the business case to which the relevant data record and hence the information object is assigned. The identification number GF_ID does not identify the data record, but allows logically interconnected data records to be recognised, as all data records assigned to the same business case contain this identification number GF_ID.

Also provided is a time-stamp field 22, in which a time stamp TS is entered. The time stamp TS represents a unique time entry, which gives an indication of the time of generation of the relevant data record. The identifier DS_K and the time stamp TS together uniquely identify the data record in question. The time stamp TS allows identification of the particular version of the data record with identifier D_SK. Data records generated at different times are given different time stamps. In this way, a historical evolution of the underlying information object can be traced from the time stamps of several data records with the same identifier D_SK.

The data record format of FIG. 2 further provides a status field 24, in which a status ST is entered. The status ST specifies a state of the information object represented by this data record. If the data model explained above is used to represent banking services, it is preferable if only such status information as is relevant to the customer is entered in the status field 24, not the information concerning the technical and internal bank processing of a business case. A status is relevant to the customer if when the corresponding state is reached, the factual or legal situation or the customer's actual options for action are changed. Thus for example, once a commercial transaction has been executed (status: executed), a customer can no longer withdraw, only cancel. The status model that defines the possible statuses should preferably be selected such that the status always reflects secured information. A status set in relation to an information object should thus mean that all process steps necessary before this status is reached are fully completed. However, the status gives no indication of whether further process steps, which must be executed after the achieved status, have already occurred.

The available statuses for various information objects can be at least partially different. In the case representing banking services, for example, statuses such as “instructed”, “accepted”, “rejected”, “deleted”, “withdrawn”, “unsuccessful” “ended as instructed”, and “ended, but not as instructed” can be defined for business case information objects 10. For transaction information objects 12, for example, further statuses such as “initiated”, “executed”, “completed”, “prepared for posting”, and “posted” can be defined in addition to the above statuses. Some of the statuses listed above can also be used for information objects 14.

In addition to the data fields 18, 20, 22 and 24, the data record format of FIG. 2 also provides further data fields 26, 28 . . . , in which further descriptive information (attributes) for the relevant information object can be stored.

FIG. 3 is now considered. This schematically shows a computer-implemented architecture, within which the invention can be applied. The architecture includes a component 30, which generates the data records for the information objects 10, 12, 14, 16 and supplies them to a downstream component 32, in which the supplied data records are stored in a database system 34. Component 30 contains software that controls the processing of customer orders to a bank. This software is set up to map the incoming customer orders in data records according to the data model shown in FIG. 1. In particular, component 30 assigns and manages the business case identification numbers. Whenever new information objects have to be created for a business case, possibly because a further transaction must be executed within a business case, component 30 generates an appropriate number of data records and supplies these to component 32. Component 30 likewise generates new data records whenever changes arise for an information object already represented by one or more existing data records, if the nature of these changes has to be reflected in the contents of the database system 34. An example of such changes is changes to the status of information objects, as explained above. But it is not only status changes that must be reflected in the contents of the database system 34. There will also be a need to reflect other changes, especially those relevant to customers, in the contents of the database system 34. Such changes include customer name and address changes, account changes and similar. In such a case, the status of the relevant information object(s) can remain unchanged, but the change must be taken into account in the contents of database system 34.

If a data record is already stored for an information object in database system 34, then provided a relevant change has occurred in connection with this information object, component 30 generates a further data record with the same identifier DS_K as the previously existing data record, but with a different time stamp TS. The further data record thus represents a younger version of the information object, while the previously existing data record represents an older version. Changes to existing data records in the database system 34 are thereby avoided. A number of versions can thus arise during the lifetime of an information object, and it can easily be established from the time stamp which version is the current one or was the last valid one.

If changes occur in connection with an information object, it can be necessary to create a further version not only for this information object, but also for one or more other information objects, which are logically linked to the one information object in question. It is preferable here if component 30 generates versions only for those information objects for which it is essential. In connection with a customer order, a different number of versions can thus arise over its life cycle for different information objects of this customer order.

FIG. 4 shows an example of a data tree for a customer order, after changes to individual information objects of the customer order have already occurred. This example of a data tree has at its head a data record 36 as the first version of a business case information object describing the customer order in general. It also contains a data record 36′, which describes another, later version of the business case information object. As discussed above, the status field of data record 36′ can contain a status other than that of data record 36, but need not. However, at least the time stamps of data records 36 and 36′ are different.

At transaction level, the data tree in FIG. 4 has one data record 38, which represents a first transaction, of which only one single version is present, and data records 40, 40′ and 40″, each representing a different version of a second transaction. Both transactions are assigned to the same business case, i.e. the data records 38, 40, 40′ and 40″ are logically linked to the data records 36 and 36′, for example by a common business case identification number.

At the transaction object level below, the data tree in FIG. 4 further contains three data records 42, 42′ and 42″, which represent three different versions of a first transaction object of the first transaction, a data record 44, which represents a single version of a second transaction object of the first transaction, and two data records 46 and 46′, which represent two different versions of a third transaction object of the first transaction. The data tree also has two data records 48 and 48′, which represent two different versions of a first transaction object of the second transaction, and a data record 50, which represents a single version of a second transaction object of the second transaction. The data records of the lowest hierarchy level are logically linked to exactly one data record of the middle hierarchy level, i.e. to exactly one transaction. To make this logical assignment recognisable, the individual transactions of component 30 can be given a unique transaction identification number—exactly as the business cases are given a unique business case identification number. This transaction identification number is entered in every data record that represents a version of the transaction in question, and in every data record that represents a version of a transaction object associated with the transaction in question. In the data format of FIG. 2, one of the further fields 26, 28, . . . could be used for entering the transaction identification number.

In the example case shown, the database system 34 comprises two databases 52 and 54, one of which, database 52, is used as the current database for saving current information, while the other database 54 serves as a historical database, to which the data records are transferred from database 52 depending on certain conditions. All the data records fed to component 32 are initially written to database 52, before they are transferred at a later time to database 54. Database 52 is considerably smaller than database 54. In an alternative embodiment, instead of a single current database 52, two or more such current databases can be provided, to which database 54 is jointly assigned. That is, database 54 receives data records from each of the multiple current databases.

The data records are transferred from database 52 to database 54 by suitable software of component 32. This software checks data records that are stored in the database 52, to see whether they meet one or more predetermined conditions. If a data record meets this or these condition(s), it at least is transferred to database 54. In a preferred embodiment, dependent on such a transfer of a data record, one or more further data records may also be transferred from database 52 to database 54. In particular, the software of component 32 can be set up to check whether older versions of a data record that is to be transferred are also present in database 52. If so, the software causes all older versions of the relevant data record, i.e. of the information object thereby represented, to be transferred as well.

In one embodiment, dependent on a data record fulfilling the transfer condition(s), all those data records that represent hierarchically subordinate information objects are also transferred. In particular, this principle can be applied if the youngest version of the top information object in the hierarchy of information objects of a business case fulfils the transfer condition(s). The entire data tree of this business case is then transferred, including any older versions of the top information object (at the business case level) and all versions of the information objects at transaction level and at transaction object level. It can even be provided that the software of the component 32 checks only data records representing the information objects of the top hierarchy level, for compliance with the predetermined transfer condition(s). In such a variant, a transfer of data records which represent information objects of a hierarchy level other than the top one occurs only when an associated data record of the top hierarchy level fulfils the transfer condition(s).

As a transfer condition, it can be provided that the status field 22 of the data record to be checked contains a predetermined status. In particular, it can be provided as a condition that the status field of the youngest version of the hierarchically top information object displays such a predetermined status. In the example case based on modelling banking services, the predetermined status can be one that shows that a customer order was ended, and no further transactions are to be undertaken by the bank within this customer order. In such an embodiment, the data records that model the various information objects of a customer order or business case are then held in database 52 until the customer order is ended. Afterwards, all these data records are transferred to database 54.

Alternatively or in addition to the above status condition, it can be provided that a checked data record must meet at least one predetermined time condition, before it is copied from the current database 52 to the historical database 54. For data records with time stamps, this can happen in the manner that the time stamp is compared with a suitable reference time, chosen as a validation criterion. If the time represented by the time stamp is before the reference time, then the checked data record has satisfied the corresponding time condition. The reference time can be specified dependent on the time at which the checking occurs, for example. For example, the reference time to be used as validation criterion can be specified such that it is a predetermined interval, e.g. seven days, before the day on which the checking of data records takes place.

The data records can be stored in the databases 52 and 54 in various tables, namely such that a first table or a set of first tables serves for storing data records which each represent an information object 10, a second table or a set of second tables is provided for storing data records which each represent an information object 12, and further a third table or a set of third tables is provided, in which those data records are stored which each represent an information object 14, and so on.

1. Computer-implemented method for data management, in which method a service provided or to be provided by a service provider is represented by electronic data on the basis of an information model, which defines a large number of different but related information objects (10, 12, 14, 16), by which the service can be represented, the method including the generating of a large number of data records which each represent one of the information objects, the data records for at least some of the information objects each containing a time stamp (TS), which represents the time of generation of the data record concerned, and the method further including the generating of several data records each representing a different version of the same information object, these data records differing from each other at least in their time stamp.

2. Method according to claim 1, characterized in that for at least some of the information objects (10, 12, 14, 16), the data records contain a status field (24) with a status entry (ST), which represents a status of the relevant information object.

3. Method according to claim 1, characterized in that at least some (10, 12, 14) of 20 the information objects (10, 12, 14, 16) are hierarchically linked to one another.

4. Method according to claim 3, characterized in that the information model defines information objects (10, 12, 14) at least on an upper, middle and lower hierarchy level, with information objects of a lower level each being assigned uniquely to one information object of a next higher level.

5. Method according to claim 1, each data record containing a service identification (GF_ID) assigned uniquely to the service.

6. Method according to claim 1, characterized in that the time stamp (TS) contains a date and a time.

7. Computer program product, which is designed to cause the execution of the method according to claim 1, when it is processed by a computer
